(19) United States
(12) Patent Application Publication
(10) Pub. No.: US 2022/0144402 A1
(43) Pub. Date: May 12, 2022

(54) Zero Emissions Marine Engine

(71) Applicant: James Hall Carrow, Riverside, CA (US)

(72) Inventor: James Hall Carrow, Riverside, CA (US)

(21) Appl. No.: 17/093,042

(22) Filed: Nov. 9, 2020

(51) Int. Cl. B63H 21/14; F02M 21/02; F02M 31/02

(52) U.S. Cl. CPC B63H 21/14; F02M 21/0275; F02M 31/02; F02M 21/0209

(57) ABSTRACT

This is a utility patent application for the design of a large marine engine that is also suitable, in different configurations, for smaller marine applications and many different power generation and transportation applications. The drawings show a ten-cylinder two-stroke engine, cylinders with a 110-inch stroke and 36-inch bore, pistons, connecting rods, and a crankshaft. The pistons are driven by the combustion of liquid hydrogen and liquid oxygen ignited by a sparking system. The engine is cooled via coolant passages in the block and head and lubricated by three separate lubrication systems. It uses cryogenic fuel pumps, electronic fuel injection, and electronic actuators regulated by a remote engine control unit. It is close to a zero emissions design, with only steam, water vapor, and extremely minute quantities of burned lubricants and trace air combustion products heading up the stack.

### CROSS-REFERENCE TO RELATED APPLICATIONS

The inventor, James Carrow, currently has two other patent applications pending, utility patent application Ser. No. 17/027,068, Zero Emissions Turbofan (With Aeroderivative Power Generation and Marine Applications) and utility patent application Ser. No. 17/026,205, Zero Emissions Power Generation Boiler. Neither one conflicts in any way with this application.

### STATEMENT REGARDING FEDERALLY SPONSORED RESEARCH OR DEVELOPMENT

[Not applicable]

### THE NAMES OF PARTIES TO A JOINT RESEARCH AGREEMENT

[Not applicable]

### INCORPORATION BY REFERENCE OF CD FILES

[Not applicable]

### STATEMENT REGARDING PRIOR DISCLOSURES BY THE INVENTOR OR JOINT INVENTOR

[Not applicable]

### BACKGROUND OF THE INVENTION

### (a) Field of the Invention

This is a design for a reciprocating marine engine suitable for use in a wide range of shipping applications, in direct and indirect drive systems and as auxiliary power in container vessels, liquefied gas carriers, bulk carriers, freighters, cruise ships, sight-seeing vessels, ferries, fishing trawlers and boats, offshore wind turbine service vessels, research vessels, submarines, yachts, pleasure craft, and small craft. In land-based versions it is also suitable for use in power generation, freight locomotives, and many different transportation, commercial and industrial applications.

The primary advantage of this design is that it completely eliminates both harmful emissions and the often immensely expensive emissions control equipment that is now mandated by law on large ocean-going ships and in many land-based applications. New International Maritime Organization Tier III and Tier IV standards regulate the emissions of many pollutants and that organization is currently working on new standards that will regulate the emissions of greenhouse gases. This design takes care of all of that with ease, eliminating 100% of known pollutants like nitrogen dioxide and sulfur dioxide, 100% of poisonous emissions like carbon dioxide, hydrogen sulfide, small particulate matter, large particulate matter, carbon black, carbon monoxide, unburned hydrocarbons, and volatile organic compounds, and 100% of the major greenhouse gases like carbon dioxide, methane, and nitrous oxide, substances that are now emitted by current marine engines.

It can do that over the whole power range of current marine and land-based diesel engines, all the way from small engines used for back-up power generation to large marine engines that generate over 100,000 horsepower.

### (b) Description of the Related Art

The inventor requested a USPTO patent search in his application. The patent office came up with one expired U.S. patent from 1975, one withdrawn Japanese patent application from 2009, and material related to the use of lubricants. The inventor will discuss each of these references.

The first is a United States utility patent granted to Patrick Underwood, in January, 1975, 47 years ago, Oxygen Hydrogen Fuel Use for Combustion Engines, U.S. Pat. No. 3,862,624. Mr. Underwood was attempting to patent a system for what he refers to as “internal combustion engines” and “the normal Otto cycle engine common to current automotive propulsion systems” by which he apparently meant a standard 1975 automotive power plant, which at the time was either an overhead cam or pushrod four-stroke engine featuring multiple cylinders, a carburetor, spark plugs, and spring-operated valves. It is not clear whether or not he meant to include diesel engines, without the spark plugs but with fuel injectors, in that description. His system, instead of using gasoline or diesel fuel, uses a mixture of hydrogen and oxygen gas.

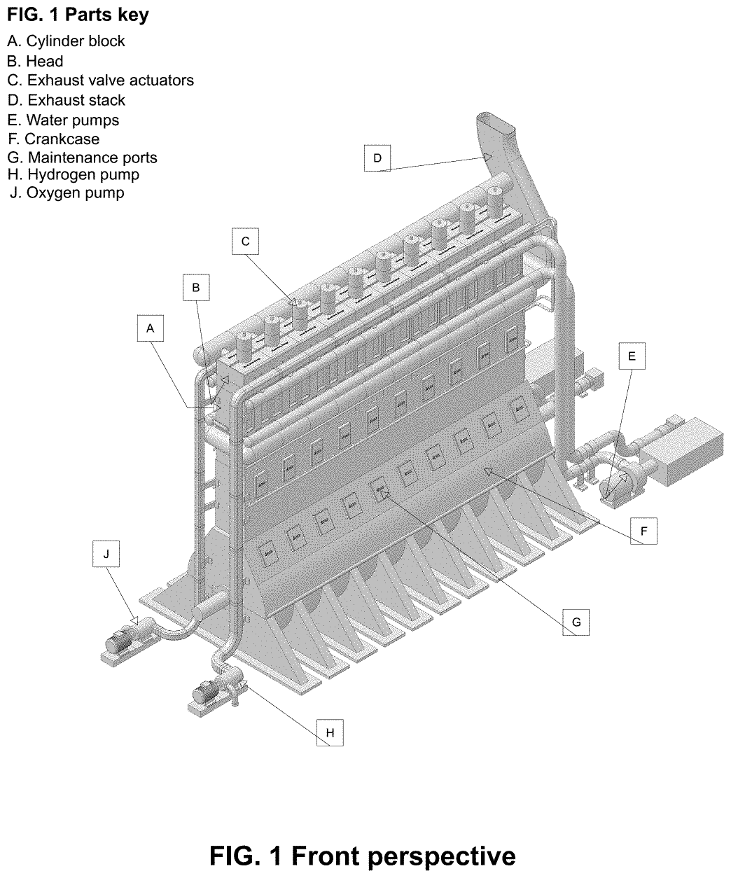

Those two fuels, in his system, are stored in liquid form, although no specifications regarding temperature or pressure are given in the patent. Unlike the design of Mr. Carrow, they are “vaporized” after leaving the fuel tanks and then pre-mixed prior to ignition. Mr. Underwood's drawing, FIG. 1, clearly shows the four heat exchangers and the mixer, labeled 23, 24, 34, 35, and 36. This is a quote from his description of the invention:

“Since liquid hydrogen and liquid oxygen respectively in the reservoirs 14 and 16 tend to emerge in cold condition from the reservoirs, it is desirable to warm these fuels before they reach the mixer 36 and are injected into the engine. To accomplish this, a pipe 42 from the oxygen reservoir 14 communicates with a jacket 43 of the heat exchanger 23 and is warmed by the heat of the engine exhaust. A pipe 44 from the jacket 43 communicates with a jacket 45 of the heat exchanger 34 where the hydrogen is warmed additionally by heat which remains present in the surplus gas returning through pipe 33, action of the heat exchangers 23 and 34 thereby serving to convert liquid hydrogen into gaseous hydrogen before it passes through a supply pipe 46 to the mixer 36.”

Unfortunately Mr. Underwood's description does not include any kind of pumping or pressure-regulating equipment, although it does include flow rate sensors and some kind of flow control. Unlike Mr. Carrow's design, Mr. Underwood's design appears to involve pistons that employ both an exhaust stroke and a compression stroke in a four-stroke [Otto] cycle, but no specifications regarding compression ratios are included in the description. It is important because hydrogen is a very flammable substance when mixed with oxygen and can easily create pre-combustion at elevated temperatures and pressures without any help from a spark or extra compression whatsoever. Therefore there is some question in tetins of whether or not this engine type would have been able to produce much power in an automobile. There is also some question as to whether or not the exhaust would contain sufficient heat to gasify the liquid fuels in the four heat exchangers prior to entering the mixer without a great deal of additional information in tetins of temperature, pressure, and flow rate. Whatever the case, it is a very different engine design from the one submitted by Mr. Carrow.

The second reference is a Japanese patent application by Shuichi Kitamura, from September, 2009, Oxygen-injection-type internal combustion engine, publication number JP 2009-203972 A. This application was later withdrawn by Mr. Kitamura without being approved. Only a very short abstract is available online but the USPTO was thoughtful enough to send along a 13-page. 10,000 word translation set in 7-point sans serif type.

Mr. Kitamura was working on reducing nitrogen dioxide emissions in automotive engines by adding a tank of compressed oxygen gas as fuel, either as the sole oxidizer or in an air-oxygen mixture. Emissions control equipment designed to do that is frequently quite expensive, often including platinum and/or palladium elements. The application includes several different designs for two-stroke and four-stroke internal combustion engines that run on a fuel described at one point as “gasoline”. However, at the very end of the application, Mr. Kitamura also includes a single paragraph that adds his thoughts on using hydrogen gas along with the oxygen, as an alternative idea.

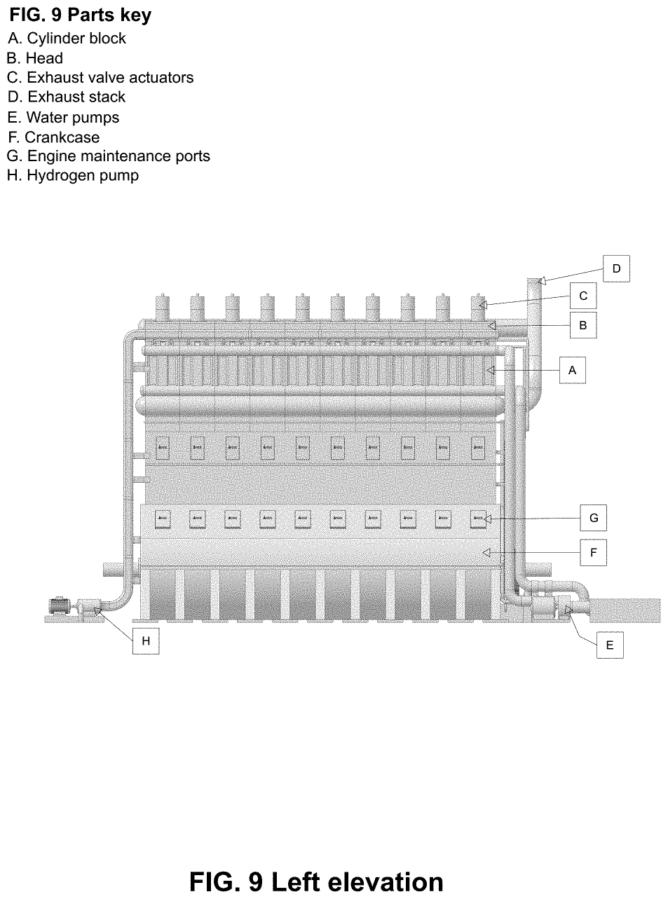

There is very little detail included in the drawing of the design, FIG. 9. He does disclose two fuel injectors, one for the hydrogen gas and one for the oxygen gas, and a spark plug or multiple spark plugs. He does give a figure for a compression ratio, 10:1, and does disclose oxygen fuel tank pressure alternatives in the following paragraph (350 or 700 bar, meaning 5,000 or 10,000 psi). He does note that there is no pre-mixing of the fuels. Other than that, one can only assume that it is similar to the other designs in the application, which means a variable-timing overhead cam with spring-driven valves in the four-stroke version and ports and a roots blower in the 2-stroke version. But in the end it is an engine driven by gas combustion, not liquid fuel combustion. He fails to give any specifications for pressure or temperature in the paragraph and fails to mention cooling or lubrication systems. There remains a question as to whether or not a hydrogen and oxygen gas-powered internal combustion engine can create enough torque and horsepower for anything larger than an small automobile. In that sense it is a very different design from Mr. Carrow's liquid fuel internal combustion engine project, which has almost unlimited power potential.

The third reference cited in the review is a 10-page brochure from Chemours, the DuPont chemical industry spin-off, in Japanese, even though the company is based in Delaware, related to its Krytox lubricant brand. Mr. Carrow's third claim describes the use of at least three specialized lubricants in his engine, due to the extremely low cryogenic temperatures in the fuel pumps, valves, lines, injectors, and cylinders, the high ignition temperature during combustion, the unfortunate tendency of both liquid hydrogen and liquid oxygen to burst into flame or explode when exposed to standard lubricating oil, and the tendency of those two elements in gas form to contaminate most oils. Specialized lubricants that remain inert and fluid when exposed to those elements have been developed and there are currently several on the market, however, the final choice has not been made in either case prior to comprehensive tests of the engine. Krytox does have the reputation of not igniting with liquid oxygen, but its lowest temperature range (−100 degrees F.) means that it is probably not suitable for use as a lubricant with either liquid oxygen (stored at −297 to −362 degrees F.) or liquid hydrogen (stored at −423 to −434 degrees F.) in the cryogenic pumps, lines, valves, fuel rails, and injectors. However, it may be a candidate for the lubricant used in the crankcase and on the connecting rods, piston rods, and piston rings. NASA uses various lubricants successfully in the cryogenic temperature range in its rockets, satellites, and equipment, so those are not an impossible physical problems to solve.

### SUMMARY OF THE INVENTION

This design for a zero emissions marine engine is an internal combustion engine with a two-stroke cycle. However, unlike modern two-strokes, its piston does not use a compression stroke, only an exhaust stroke. Instead, the two liquid fuels are injected into the cylinder near the top of that exhaust stroke, after the exhaust valve has closed, and create the pressure for the power stroke themselves by means of combustion and gasification, brought about by a sparking system. There is a very large single solenoid-powered exhaust valve at the top of each cylinder along and exhaust ports at the bottom.

The fuel is contained in pressurized cryogenic fuel tanks that include temperature, pressure, and boil-off regulation systems and purging systems. The fuel is sent under pressure to a booster pump and then to the main fuel pump, where pressure is generated for the fuel injection systems.

The engine cylinders and head are cooled by engine coolant run through a seawater-cooled heat exchanger in the marine version and by a large fan-cooled radiator in the land-based versions. There are dual lubrication systems for the two fuels, plus a third for the solenoids, valve stems, cylinders, piston rings, connecting rods, and crankcase. The design shown in the drawings is a large (36-inch bore and 110-inch stroke) two-stroke direct drive marine engine.

### DESCRIPTION OF THE SEVERAL VIEWS OF THE DRAWINGS

This utility patent application includes 9 drawings: two perspective renderings, two cutaway perspective sections, a plan, and four elevations. The drawings are shaded black and white design drawings.

These are basic design development drawings, showing major design elements, and do not show most connections, including nuts, bolts, and welds; most of the wiring; most of the valves and sensors and some of the actuators; the electronic monitoring and engine control systems; the fuel tanks and bunkers; the propeller shaft and propeller; auxiliary drive engines and gensets, including the one used for starting this engine; and most latches, bearings, seals, gaskets, and O-rings.

Material types are not shown. At this time it appears that the major materials will include aluminum alloys, stainless steel alloys, nickel-chromium alloys, foam insulation, iron alloys, copper alloys, carbon steel alloys, and various composite materials.

Five pumps are shown, including the liquid hydrogen and liquid oxygen fuel pumps, two water pumps, and an oil sump pump.

The nine drawings submitted are listed as follows:

1. 1/9 FIG. 1 Front perspective: This is a shaded perspective rendering viewed from the front left side of the engine. It shows the cryogenic liquid hydrogen and liquid oxygen pumps in the foreground, the insulated cryogenic fuel rails, the ten large solenoids that activate the upper exhaust valves at the top, the left side of the exhaust system, the left exterior side of the water cooling system, and the left side engine coolant pump and seawater heat exchanger to the rear.

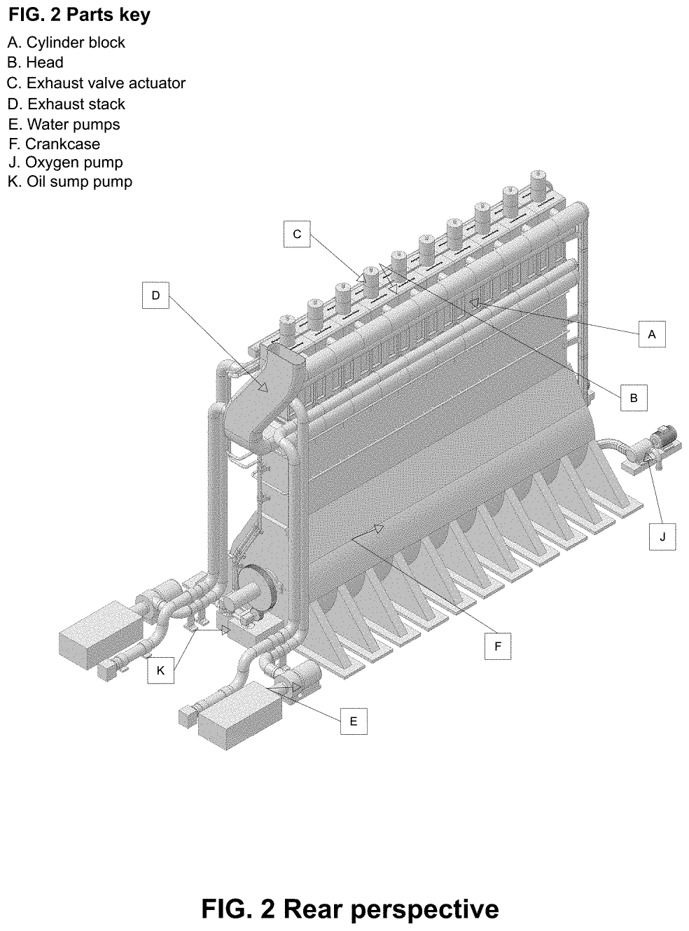

2. 2/9 FIG. 2 Rear perspective: This is a shaded perspective rendering viewed from the rear right side of the engine. It shows the two engine coolant pumps and seawater heat exchangers to the rear, the crankshaft flywheel, oil sump and pump, and oil system lines at the back end of the engine, the right exterior side of the water cooling system, and the right side and stack of the exhaust system. Not shown is the rear crankshaft connection to the auxiliary drive unit used to start the engine.

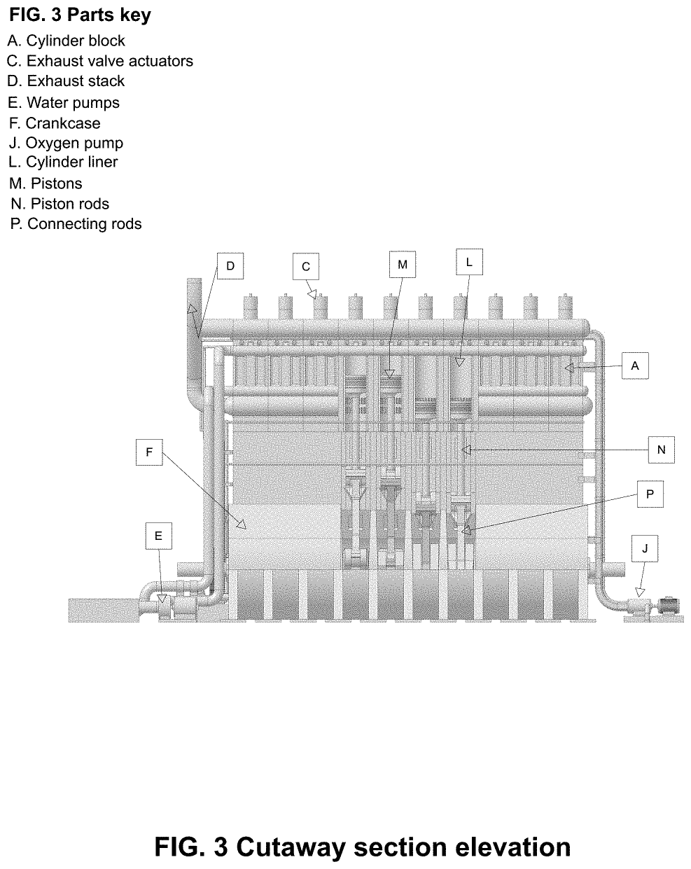

3. 3/9 FIG. 3 Cutaway section elevation: This is a shaded cutaway section view of the right elevation, showing a section taken through the central four cylinders of the engine at the midpoint of the engine block. It shows the four cylinder liners with the exhaust ports at the bottom, the four pistons and their piston rings, the piston rods, the piston connecting rods, and the four crankshaft sections and their connections, all in elevation.

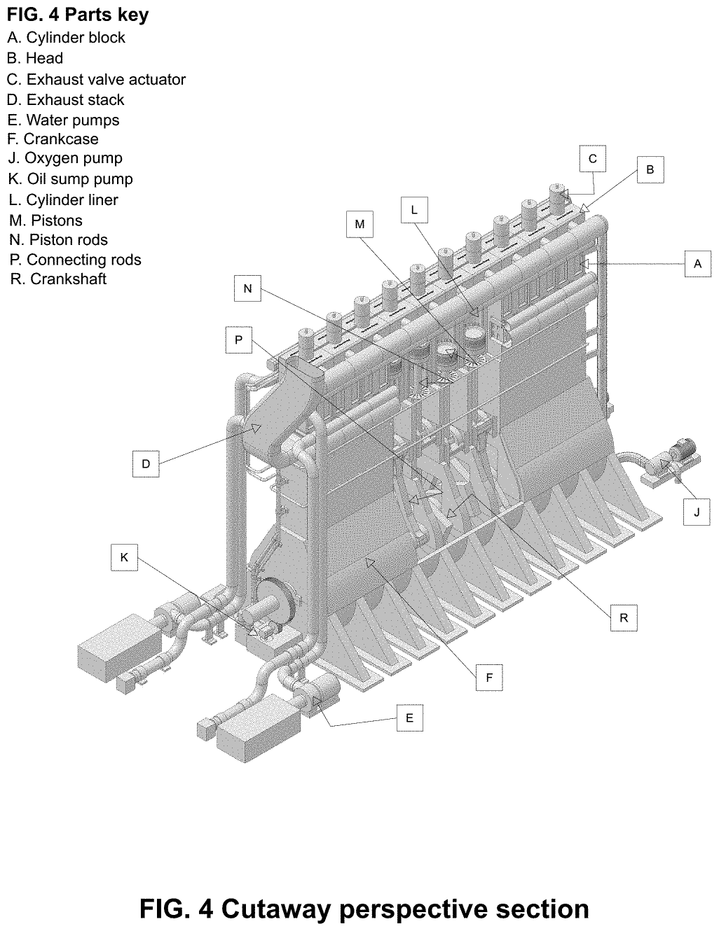

4. 4/9 FIG. 4 Cutaway section perspective: This is a shaded perspective view of the cutaway section of the central four cylinders viewed from the rear right side of the engine, showing the piston heads and the perforated plates at the bottom of the cylinder liners.

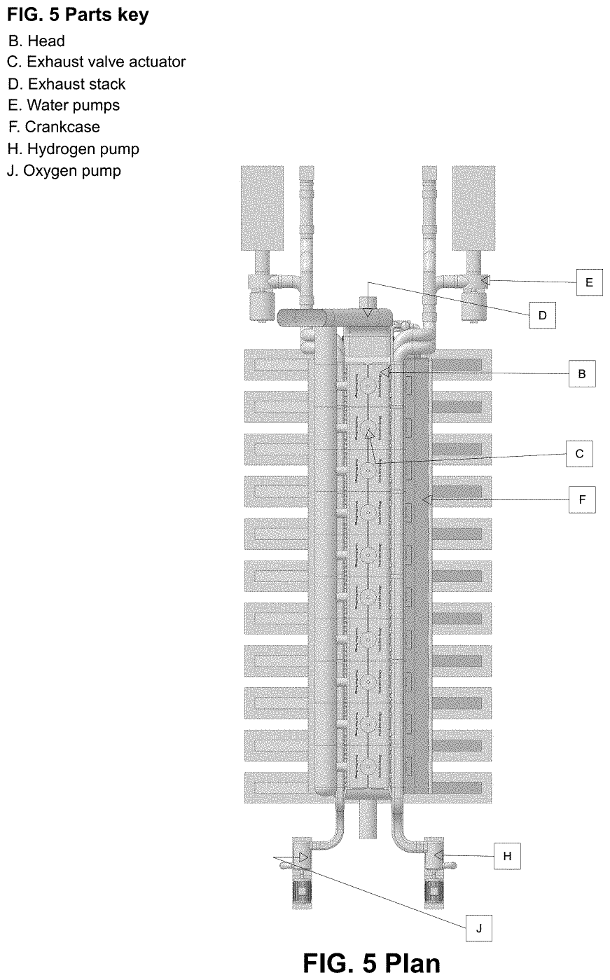

5. 5/9 FIG. 5 Plan: This is a shaded plan view of the engine taken from above the engine. It shows the engine coolant pumps and seawater heat exchangers at the top of the drawing, the ten large solenoids of the upper exhaust valves and twenty cylinder head covers in the middle, and the cryogenic hydrogen and oxygen pumps at the bottom.

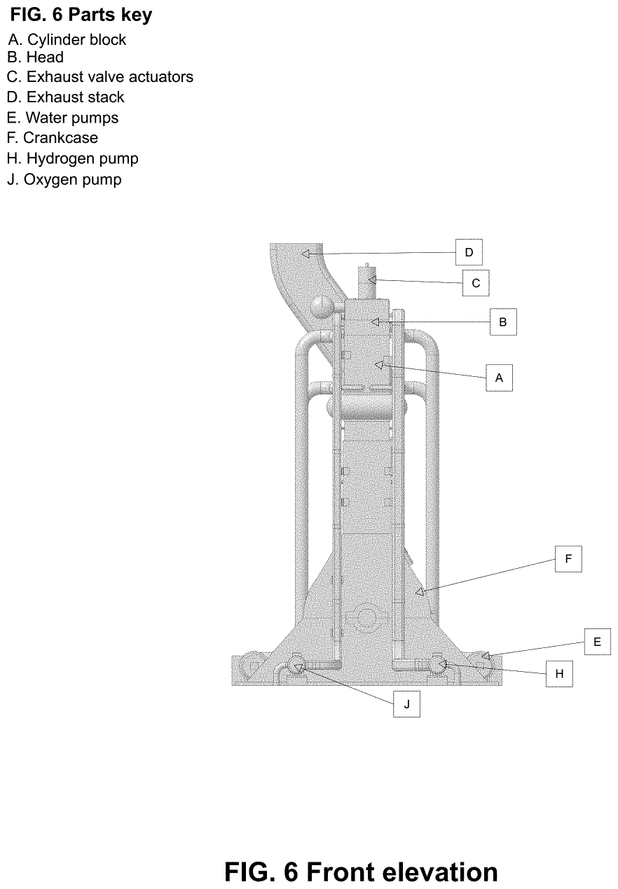

6. 6/9 FIG. 6 Front elevation: This is a shaded elevation of the front view of the engine showing the cryogenic liquid hydrogen and oxygen pumps and the insulated cryogenic fuel supply rails in the foreground.

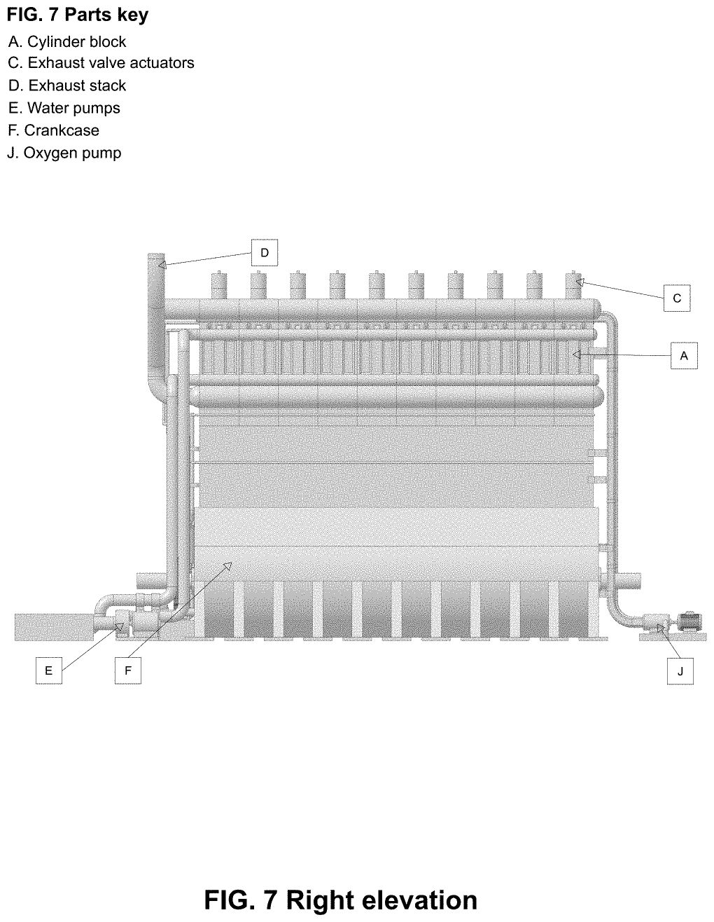

7. 7/9 FIG. 7 Right elevation: This is a shaded elevation view of the right side of the engine.

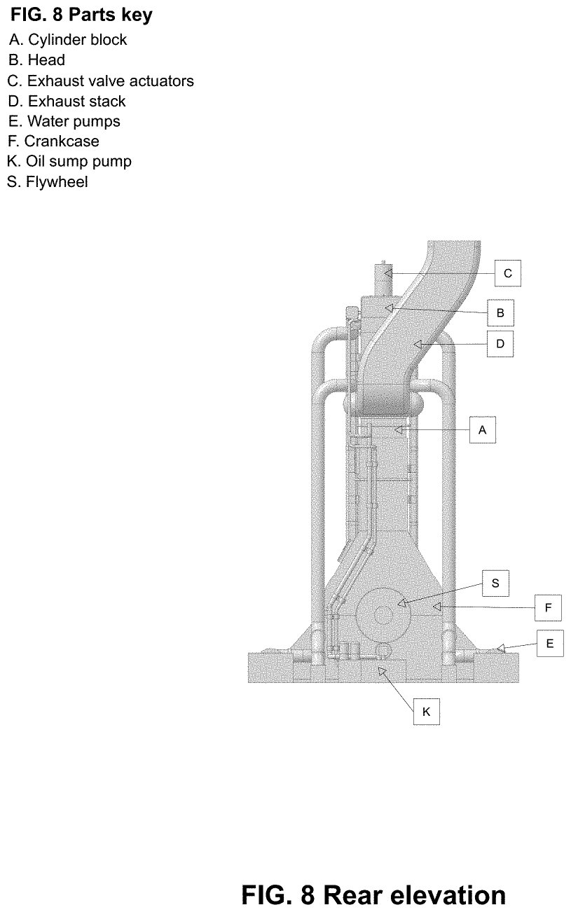

8. 8/9 FIG. 8 Rear elevation: This is a shaded elevation view of the rear of the engine showing the crankshaft flywheel and the main cylinder, crankcase, and connecting rod lubrication sump, pump, and lines at the rear of the engine.

9. 9/9 FIG. 9 Left elevation: This is a shaded elevation of the left side of the engine. It shows the twenty ports used to service and disconnect the connecting rods and piston rods, employed when removing the heads, pistons, piston rings, cylinder liners, and those rods for servicing and general maintenance. The entire upper section of the engine is also removable so that the crankshaft and its connections can be removed and serviced.

### DETAILED DESCRIPTION OF THE INVENTION

This is a utility patent application for a large marine engine, suitable for use in direct drive propeller shaft systems in the largest ships in the world, including 24,000 TEU container ships and 400,000 ton Chinamax bulk carriers, and also suitable, in different configurations, different sizes, and in genset versions, for a wide range of ships, smaller boats, and submarines, for land-based transportation uses like freight locomotives, and for a very wide range of commercial, industrial, and power generation applications.

The design shown in the nine drawings is a two-stroke ten-cylinder model that runs on the combustion of liquid hydrogen and liquid oxygen, used to power cylinders designed with a 36-inch bore and a 110-inch stroke that run between 20 and 120 rpm. In this design the fuel enters the top of each cylinder using 12 solenoid-actuated injectors, 6 for each fuel type arranged in pairs, after which the fuel is ignited by 6 large electronic sparking units, one placed between each pair of injectors. The combustion of the two fuels creates steam and the piston power stroke, at the bottom of which are exhaust ports for the steam. At bottom dead center of the stroke, a very large exhaust valve at the top of the cylinder is opened by a large solenoid actuator and the piston goes into its exhaust stroke, clearing the remaining steam from the cylinder until, just before top dead center of the stroke, the exhaust valve closes, followed by the firing of the injectors and the electronic sparking units at or near top dead center, depending upon the actuation of adjustable electronic timing controls. The cylinders feature a removable head and liner (the fuel lines, injectors, sparking units, pistons and connecting rods are also removable) surrounded by coolant passages in the cylinder block and in the head, near the exhaust valve. The system is designed so that it can be controlled by a remote electronic engine control unit capable of adjusting the timing of each of the electronic components and wired into crankshaft, piston, and actuator timing sensors and pressure and temperature sensors located in and around the cylinders.

The fuel is supplied by separate fuel rails for the liquid hydrogen and liquid oxygen, which are supplied by the two large fuel pumps located in front of the engine, which are, in turn, fed by booster pumps located at the fuel tank outlet valves.

The coolant is supplied by the two large engine coolant pumps at the rear of the engine, which are in turn supplied by seawater heat exchanger systems applicable to most prospective installations.

The crankshaft bearings, connecting rods and bearings, and the pistons, piston rings, and piston rods and their slides are lubricated by a special hydrogen-resistant and oxidation-resistant lubricant supplied by an oil sump and sump pump driven by the engine flywheel at the rear of the engine.

The exhaust exits through a large system at the rear of the engine which would be connected to the ship's stack.

The engine head covers, fuel lines, head, and exhaust valve system are removable, as are the coolant and lubricant exterior lines. The engine features operable side ports for access to the piston and connecting rods bolts for the purposes of removal and repair. The cylinder block is removable and the crankcase is designed in two bolted parts which can be separated for repair of the crankshaft and crankshaft bearings in major engine overhauls.

This design is similar to current marine diesels in that it uses very similar crankshaft, connecting rod, piston, and engine cooling systems. That is pretty much where the similarity ends. This engine will feature close to zero emissions, as the exhaust will be steam and water vapor plus very minute amounts of burned lubricants and trace elements of combustion with air. While this is a two-stroke design, the lubricant is not mixed with the fuel, as in many current versions, but is applied through a classic diesel lubricating system. The fuel enters the fuel rails, injectors, and cylinder in a 100% pure state. As such, this engine will easily comply with the International Maritime Organization's Tier III and Tier IV standards and the greenhouse gas emissions standards it is about to issue without the use of any bulky and expensive emissions control systems whatsoever.

In addition, this design differs from diesel engines and modern two-stroke engines in that there is no real piston compression stroke, because the two cryogenic fuels supply their own compression during gasification and combustion at the top of the cylinder. There will only be a very small amount of compression in the remaining steam just before top dead center of the exhaust stroke, after the exhaust valve closes. The two fuels will be injected into the cylinders where the pressure above the piston may be as low as 15-50 psi, depending upon timing, much lower than any known diesel or gasoline engine. This will create a very different combustion dynamic, where the atomization, gasification, and combustion of the fuel will depend on the design of the injector head and orifice and the temperature and phase of the fuel, rather than injection into a high-pressure environment.

For these reasons power, in tetins of horsepower and torque, per cubic inch of cylinder displacement should also be much greater than in any existing diesel design of comparable size.

This design also differs from any existing diesel in that it employs cryogenic fuels. Today hundreds of huge LNG tankers roam the world's seas, carrying massive tanks filled with cryogenic fuel. Some of them use the boil-off from their tanks to help power their engines. It is basically the same phase issue that faces this engine, but on a different scale. Cryogenic fuels tend to go into turbulent, multi-phase states and non-laminar flows when pumped through fuel lines and injectors, and that is the expectation in this engine's pumps and fuel lines as well. In addition, current cryogenic fuel tanks are not designed to maintain a specific fuel temperature, but that is an issue that the inventor is currently working on in separate projects, and it may turn out to be practical to attach electronically controlled and powered cryocoolers to the ship fuel bunkers for that purpose, especially in the case of the liquid hydrogen fuel tanks. Those cryocoolers would also serve to drastically reduce fuel boil-off rates. Pumping the fuel under relatively high pressure also lessens the phase transition issue as it raises the boiling point of the fuel. These are issues which will have to be analyzed in working models of the engine.

Finally, this design differs from existing ship diesels in that it employs a sparking system. At this time the cylinder is being designed with a direct injection system, due in large part to the rather large cylinder volume. Hydrogen/oxygen combustion features an extremely rapid flame spread, but in liquid form the two fuels do not fully ignite and burn without the help of a large amount of initial heat, which is supplied in the form of an electric sparking system in this design. The precise design, size, and orientation of the fuel injectors and the precise amount of amperage that will be needed by the sparking system are details that will have to be worked out during the development of the working models.

Testing of working models may also demonstrate the need for an electric heating system in the head for the purposes of starting and shutting down the engine. This has yet to be determined, but icing and incomplete combustion problems could develop in start-up and shut-down modes. Start-up modes will also require a fuel pump, fuel line, and fuel injector cool-down phase, which will require running the engine slowly using a gaseous ignition mode for a short period of time until the lines cool down and it can transition into a liquid ignition mode. In addition, the fuel lines will require a series of pressure relief valves and check valves for start-up and shut-down modes as well as for general engine safety. It may turn out that the fuel lines and pumps will also require attached vacuum pumps for start-up and shut-down operations and for purging the lines, valves, pumps, and injectors.

The starting system is not shown. At this time it is envisioned that an auxiliary engine, temporarily connected to the rear shaft by means of gearing systems, will be used for the starting phase.

The propeller shaft and propeller are not shown. These designs will depend on the overall ship design, and may or may not include a gearbox and a power take-off system. The two fuel pumps and two water pumps shown are driven by large electric motors.

In terms of installations in actual ships, this engine will require specially-designed fuel tanks and fuel bunkers and the development of new fuel supply systems at ports and marine depots, along with the requisite service, maintenance, and training facilities. It will also require special permitting and regulatory approval and a period of working model design and testing and sea trials.

Smaller versions of this engine are also envisioned, and the design can be used on everything from yachts, tugboats, ferries, fishing trawlers, submarines, research vessels, cruise ships, sight-seeing craft, dinner cruises, and offshore wind turbine service craft all the way up to the largest ships in the world.

This engine type also has many power generation applications, including utility-scale power plants, municipal power facilities, industrial power plants, and institutional and commercial back-up power generation, including large data center and server primary and back-up power, along with general industrial and commercial power applications. In addition, it also has several transportation applications in smaller sizes, including freight train locomotive power plants and large off-road industrial vehicle power. Technically, it could also be used as a truck engine on 18-wheel tractor-trailers if the demand arises in that sector and it receives regulatory approval, and it could also be used to power drag racers and off-road racing bikes, cars, and trucks, if the financing for projects like that ever actually materializes, which has not happened to date.

1. It is claimed that this is a unique design for a potentially very powerful (capable of producing over 100,000 horsepower) two-stroke internal combustion engine that burns liquid hydrogen fuel with a liquid oxygen oxidizer and that employs an upwards exhaust stroke of the piston in place of a compression stroke on its return to top dead center in the cycle, the compression being supplied by the vaporization and combustion of the two pressurized fuels entering from fuel injectors and ignited by an electronic sparking system at or near top dead center of the cycle.

2. It is claimed that this design is unique due to the combination of its tremendous power potential (over 100,000 horsepower) and lack of harmful emissions and its almost complete elimination of all forms of polluting, poisonous, and greenhouse gas emissions, as the only elements emitted will be steam, water vapor, and extremely minute traces of burned lubricants and trace air combustion products, thus eliminating the need for all of the expensive engine emissions control equipment now mandated by maritime and land-based laws, statutes, and regulations.

3. It is claimed that this powerful 2-stroke internal combustion engine design is unique in that it will feature specialized and differentiated lubricants and lubrication systems for [a] its cryogenic hydrogen tanks, lines, valves, pumps, fuel rails and injectors, [b] its cryogenic oxygen tanks, lines, valves pumps, fuel rails, and injectors, and [c] its crankcase, connecting rods, pistons and rings, cylinder liners, valve stems, solenoids, and oil and water pumps.
